(19) United States
(12) Patent Application Publication
(10) Pub. No.: US 2005/0123038 A1
(43) Pub. Date: Jun. 9, 2005

(54) Moving image encoding apparatus and moving image encoding method, program, and storage medium

(75) Inventors: Katsumi Otsuka, Kawasaki-shi (JP); Hideaki Hattori, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/003,461

(22) Filed: Dec. 6, 2004

(30) Foreign Application Priority Data
Dec. 8, 2003 (JP) 2003-409357
Feb. 24, 2004 (JP) 2004-048173

(51) Int. Cl. H04N 7/12

(52) U.S. Cl. 375/240.03; 375/240.14; 375/240.29; 375/240.24

(57) ABSTRACT

A moving image encoding apparatus which has an encoding unit for quantizing and encoding a moving image, and a decoding unit for locally decoding the encoded data, includes a pre-filter for applying a spatial filter process to the input moving image in accordance with a filter coefficient which can be variably set according to an encoding condition, a calculation unit for calculating a block distortion level of the moving image on the basis of the moving image output from the pre-filter and a decoded image output from the decoding unit, and a determination unit for determining a parameter that changes a setup of at least one of the filter coefficient and a quantization scale required to control quantization in the encoding unit in accordance with the calculated block distortion level and a rate for the moving image encoded by the encoding unit.

### FIELD OF THE INVENTION

The present invention relates to a moving image encoding apparatus and moving image encoding method for outputting encoded data and, more particularly, to an image encoding apparatus and image encoding method which can obtain high image quality even at a low bit rate, and the like.

### BACKGROUND OF THE INVENTION

With the rapid progress of digital signal processing techniques in recent years, recording of moving images on storage media and transfer of a moving images via a transmission path, which are difficult to achieve by the conventional techniques, are made. In this case, each individual frame that forms a moving image undergoes a compression process to greatly reduce its data size. As a typical method of this compression process, for example, MPEG (Moving Picture Experts Group) is known. When an image is compressed and encoded in conformity to MPEG, its rate (the rate) often largely differs depending on the spatial frequency characteristics as those of an image itself, a scene, and a quantization scale value. An important technique that allows to acquire a decoded image with high image quality upon implementing an encoding apparatus having such encoding characteristics is rate control.

As one of rate control algorithms, TM5 (Test Model 5: Test Model Editing Committee: “Test Model 5”, ISO/IEC JTC/SC29/WG11/NO400 (Apr.1993))) is known. The rate control algorithm based on TM4 includes three steps to be reviewed below, and controls the bit rate to obtain a constant bit rate per GOP (Group of Picture).

[Step 1: Target Bit Allocation]

In the process of STEP 1, the target rate of the next picture to be encoded is set. In the process of STEP 1, rate Rgop allowed in the current GOP is calculated (“*” in the following equations means multiplication) by:
Rgop=(ni+np+nb)*(bits_rate)/picture_rate) (1)
where ni, np, and nb are the remaining numbers of I—, P—, and B-pictures in the current GOP, bits_rate is the target bit rate, and picture_rate is the picture rate. Furthermore, picture complexities are calculated from the encoding results for I—, P—, and B-pictures by:
Xi=Ri*Qi
Xp=Rp*Qp
Xb=Rb*Qb (2)
where Ri, Rp, and Rb are the rates respectively obtained as a result of encoding I—, P—, and B-pictures, and Qi, Qp, and Qb are Q-scale reference values of all macroblocks in I—, P—, and B-pictures. From equations (1) and (2), target rates Ti, Tp, and Tb of I—, P—, and B-pictures can be calculated by:
Ti=max((Rgop/(1+((Np*Xp)/(Xi*Kp))+((Nb*Xb)/(Xi*Kb)))), (bit_rate/(8*picture_rate))}
Tp=max((Rgop/(Np+(Nb*Kp*Xb)/(Kb*Xp))), (bit_rate/(8*picture_rate))}
Tb=max((Rgop/(Nb+(Np*Kb*Xp)/(Kp*Xb))), (bit_rate/(8*picture_rate))} (3)
where Np and Nb are the remaining numbers of P— and B-pictures in the current GOP, and constants Kp=1.0 and Kb=1.4.
[Step 2: Rate Control]

In STEP 2, three virtual buffers are used in correspondence with I—, P—, and B-pictures to manage the differences between the target rates calculated using equations (3) and generated rates. The data storage sizes in the virtual buffers are fed back, and Q-scale reference values are set for the next macroblock to be encoded, so that the actual generated rates approach the target rates on the basis of the data storage sizes. For example, if the current picture type is P-picture, the difference between the target rate and generated rate can be calculated by an arithmetic process given by:
dp,j=dp,0+Bp,j−1−((Tp*(j−1))/MB_{—}cnt) (4)
where suffix j is the macroblock number in the picture, dp,0 is the initial fullness of the virtual buffer, Bp,j is the total rate up to the j-th macroblock, and MB_cnt is the number of macroblocks in the picture. The relationship of equation (4) is represented by a graph, as shown in FIG. 2.

Referring to FIG. 2, the abscissa plots the number of macroblocks (MB_cnt) in the picture, and the ordinate plots the target rate of P-picture. Dp,j in FIG. 2 is the difference value calculated using equation (4).

The Q-scale reference value of the j-th macroblock is calculated using dp,j (to be referred to as “dj” hereinafter) by:
Qj=(dj*31)/r (5)
for r=2*bits_rate/picture_rate (6)
[Step 3: Adaptive Quantization]

In STEP 3, a process for finally determining the quantization scale value on the basis of the spatial activity of a macroblock to be encoded so as to improve the visual characteristics, i.e., the image quality of a decoded image is executed.
ACTJ=1+min(vblk1, vblk2, . . . , vblk8) (7)
where vblk1 to vblk4 are spatial activities in 8×8 subblocks in a macroblock with a frame structure, and vblk5 to vblk8 are spatial activities of 8×8 subblocks in a macroblock with a field structure. Note that the spatial activity can be calculated by:
vblk=Σ(Pi−Pbar)² (8)
Pbar=(1/64)*ΣPi (9)
where Pi is a pixel value in the i-th macroblock, and Σ in equations (8) and (9) indicates calculations for i=1 to 64. ACTJ calculated by equation (7) is normalized by:
N_{—}ACTJ=(2*ACTj+AVG_{—}ACT)/(ACTj+AVG_{—}ACT) (10)
where AVG_ACT is a reference value of ACTj in the previously encoded picture, and the quantization scale (Q-scale value) is finally calculated by:
MQUANTj=Qj*N_{—}ACTj (11)

According to the aforementioned TM5 algorithm, by the process in STEP 1, a larger rate is assigned to I-picture, and a larger rate is allocated to a flat portion (with low spatial activity) where deterioration is visually conspicuous.

In Japanese Patent No. 2894137 as a technique proposed to solve the problems of TM5, a “balance function” is defined to obtain a balance point of the cutoff frequency of a low-pass filter (LPF), as shown in FIG. 3, and quantization distortion and image sharpness deterioration are matched to solve the problems of TM5. This technique is implemented by reducing the spatial frequency of each picture to be input to an encoding apparatus by the LPF so as to suppress quantization distortion. Two curves in FIG. 3 correspond to the following two functions F1 and F2.

F1 (motion amount, filter coefficient, quantization scale, rate)

F2 (filter coefficient, quantization scale)

An intersection between the functions F1 and F2 is set as a balance point, and values at that point are set as a quantization scale and LPF filter coefficient that can optimize matching between the rate and image quality.

Japanese Patent Laid-Open No. 2002-247576 discloses a technique that avoids an abrupt change upon changing a filter coefficient as a moving image encoding method.

However, the aforementioned TM5 algorithm suffers the following problems. That is, as decision-making information required to obtain final MQUANTj, only the Q-scale reference value (Qj) of the encoding result of the previous picture in equation (5) and spatial activity (ACTj) in the process in STEP 3 are used in addition to the difference (deviation) between the target rate and generated rate in equation (4). Hence, the degree of qualitative deterioration of image quality and human visual characteristics are not sufficiently considered in rate control of TM5, and it is difficult for TM5 to perform rate control that matches the human visual characteristics in correspondence with the encoding state.

Even in the technique of Japanese Patent No. 2894137 that compensates for the problems of the TM5 algorithm, a large-scale circuit is required to calculate “motion amount” as an argument in the above function F1. Furthermore, since only information of the immediately preceding picture is used, the generated rates increase abruptly in a case where a scene change or the like is generated. Since the filter characteristics change abruptly in order to suppress the increment of the generated rates, unsharp image quality becomes conspicuous.

According to Japanese Patent Laid-Open No. 2002-247576 which discloses the solving method that avoids an abrupt change upon changing a filter coefficient as a moving image encoding method, an encoding difficulty Y is calculated for each of I—, P—, and B-pictures using a function given by:
Y=F(accumulated rate, average Q-scale) (12)

From the encoding difficulties Yi, Yp, and Yb calculated for I—, P—, and B-pictures, a filter coefficient parameter Z is calculated by:
Z=(Yi+Yp+Yb)/(bits_rate) (13)

According to the value Z obtained by equation (13), a filter coefficient is selected from filter coefficients S0, S1, and S3 which are set in advance, as shown in FIG. 4. More specifically, by providing a range to the value Z corresponding to each filter coefficient, an abrupt change in filter coefficient is avoided.

However, the method according to Japanese Patent Laid-Open No. 2002-247576 above makes simple prediction from only information of the accumulated rate and average Q-scale. Hence, the degree of deterioration of image quality and human visual characteristics are not sufficiently considered yet.

### SUMMARY OF THE INVENTION

The present invention has been proposed to solve the conventional problems, and has as its object to provide a moving image encoding apparatus and moving image encoding method, which consider the degree of deterioration of image quality and human visual characteristics. In order to achieve the above object, a moving image encoding apparatus and the like according to the present invention are characterized by mainly having the following arrangements.

The above-described object of the present invention is achieved by a moving image encoding apparatus which has encoding means for quantizing and encoding a moving image, and decoding means for locally decoding the encoded data, comprising:
a pre-filter for applying a spatial filter process to the input moving image in accordance with a filter coefficient which can be variably set according to an encoding condition;
calculation means for calculating a block distortion level of the moving image on the basis of the moving image output from the pre-filter and a decoded image output from the decoding means; and
determination means for determining a parameter that changes a setup of at least one of the filter coefficient and a quantization scale required to control quantization in the encoding means in accordance with the calculated block distortion level and a rate for the moving image encoded by the encoding means.

Furthermore, the above-described object of the present invention is also achieved by a moving image encoding apparatus for encoding an input image to a predetermined target rate using a weighting parameter in a quantization process in moving image encoding that encodes a moving image for respective predetermined units, comprising:
variance calculation means for calculating a variance of the input image;
filter means for applying a filter process to the input image in accordance with given filter characteristics;
encoding means for encoding the input image that has undergone the filter process by the filter means by executing a quantization process;
decoding means for applying a decoding process to encoded data output from the encoding means;
detection means for detecting block distortion from an input image to the encoding means and a reconstructed image as an output from the decoding means;
specifying formula determination means for determining a specifying formula used to specify a relationship between a rate and encoding distortion amount in the encoding means;
evaluation formula determination means for determining an evaluation formula used to evaluate visual sensitivity including the variance calculated by the variance calculation means and at least the detection result of the detection means; and
parameter calculation means for calculating the filter characteristics in the filter means and a weighting parameter in a quantization process on the basis of the target rate of the input image, the specifying formula, and the evaluation formula.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of a moving image encoding apparatus 200 that can implement a moving image encoding method according to the present invention;

FIG. 2 is a graph for explaining STEP 2 in the rate control algorithm (TM5);

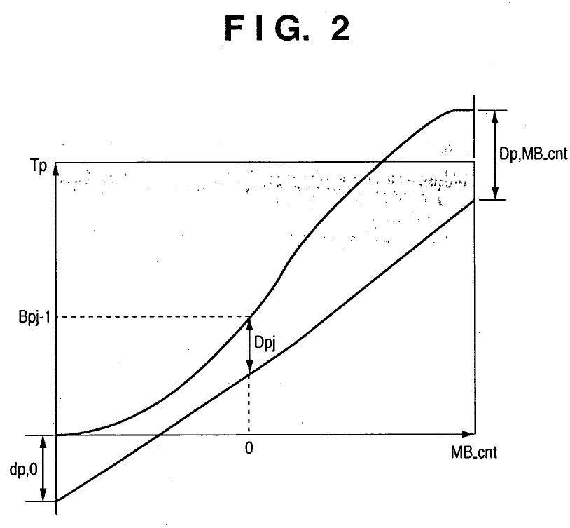

FIG. 3 is a graph for explaining the balance function defined in Japanese Patent No. 2894137;

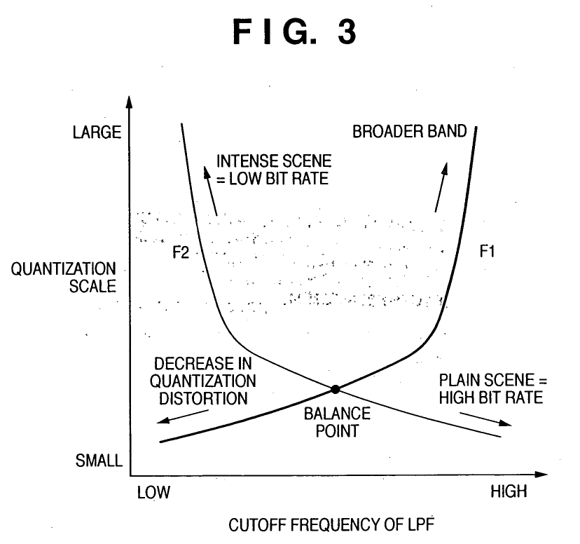

FIG. 4 is a graph for explaining a process for determining a filter coefficient in the prior art;

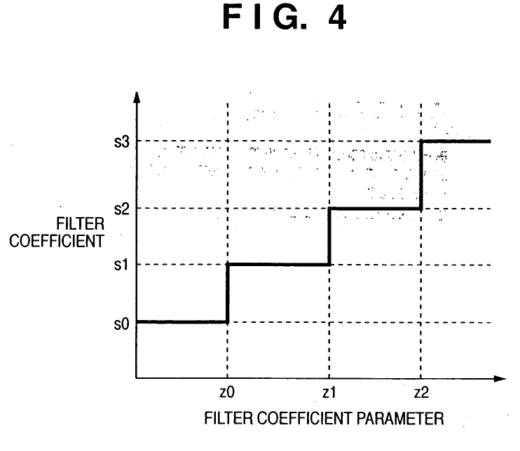

FIG. 5 is a flowchart for explaining the flow of a moving image encoding process according to the embodiment of the present invention;

FIG. 6 shows an example of a spatial filter of a 3×3 square matrix;

FIG. 7 is a table showing the relationship between the filter coefficients (C_LPF) and those of the 3×3 square matrix;

FIG. 8 shows a macroblock and boundary pixels of an 8×8 pixel block that forms the macroblock;

FIG. 9 is a flowchart for explaining an encoding parameter determination process according to the embodiment of the present invention;

FIGS. 10A and 10B are views for explaining three areas (AREA) that classify block distortion levels BN;

FIGS. 11A and 11B show the configurations of data tables showing the relationship between the filter coefficients (C_LPF) and constants (ADD_Q) to be added to a quantization scale value (Q) in correspondence with block distortion levels (BN);

FIG. 12 shows an example of pictures to be encoded;

FIG. 13 is a block diagram showing the arrangement of a block distortion level calculation unit 109;

FIG. 14 is a block diagram showing the arrangement of an encoding parameter determination unit 110;

FIG. 15 is a block diagram showing the arrangement of a moving image encoding apparatus according to the second embodiment of the present invention;

FIG. 16 is a flowchart showing a process to be executed by the moving image encoding apparatus according to the second embodiment of the present invention;

FIG. 17 is a view for explaining pictures to be encoded according to the embodiment of the present invention;

FIG. 18 is a graph showing the characteristics of an R-D model used in the second embodiment of the present invention;

FIG. 19 is a table for explaining the relationship between the parameters and coefficients used in the second embodiment of the present invention;

FIG. 20 is a graph for explaining selection of pre-filter characteristics in the second embodiment of the present invention;

FIG. 21 is a block diagram showing the arrangement of a moving image encoding apparatus according to the third embodiment of the present invention;

FIG. 22 is a flowchart showing a process to be executed by the moving image encoding apparatus according to the third embodiment of the present invention;

FIG. 23 is a view for explaining the structure of a sequence in the third embodiment of the present invention;

FIG. 24 is a flowchart showing an MPEG-4 encoding process according to the third embodiment of the present invention;

FIG. 25 is a graph for explaining the characteristics of an I-picture R-D model used in the third embodiment of the present invention;

FIG. 26 is a graph for explaining the characteristics of an I-picture R-D model used in the third embodiment of the present invention; and

FIG. 27 is a graph showing the relationship between the frequency of an input picture and filtered frequency in the third embodiment of the present invention.

### DETAILED DESCRIPTION OF THE PREFERRED EMBODIMENTS

Preferred embodiments of the present invention will now be described in detail in accordance with the accompanying drawings.

### First Embodiment

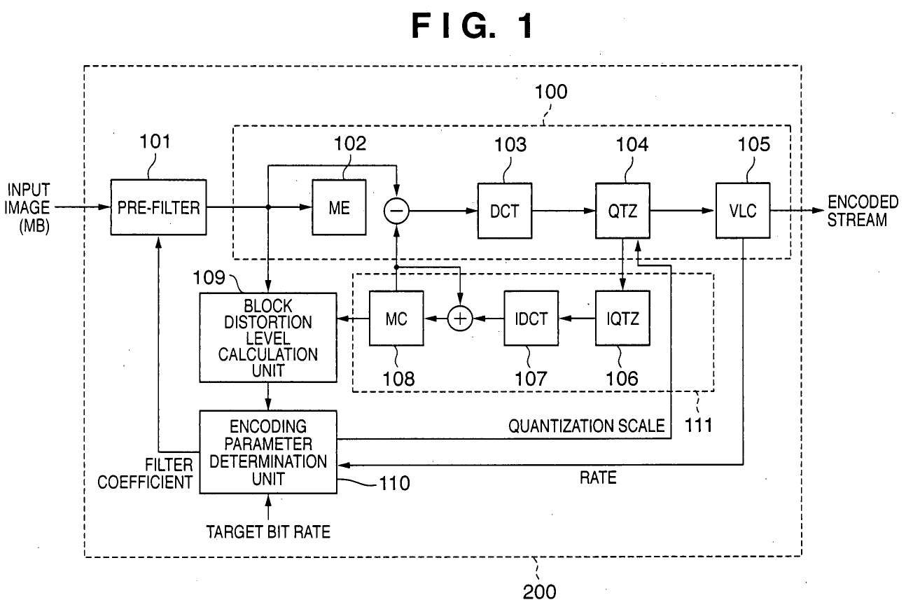

FIG. 1 is a block diagram showing the arrangement of a moving image encoding apparatus 200 that implements a moving image encoding method according to the first embodiment of the present invention. The apparatus 200 utilizes an MPEG encoding unit 100 that can execute the aforementioned TM5 algorithm. More specifically, the MPEG encoding unit 100 supports MPEG-1, MPEG-2, or MPEG-4 standard, and is not limited to a specific encoding standard. That is, the moving image encoding technique according to the present invention can be applied as long as the encoding standard includes an arrangement that quantizes an input image (an arrangement corresponding to a QTZ 104 as a quantizer).

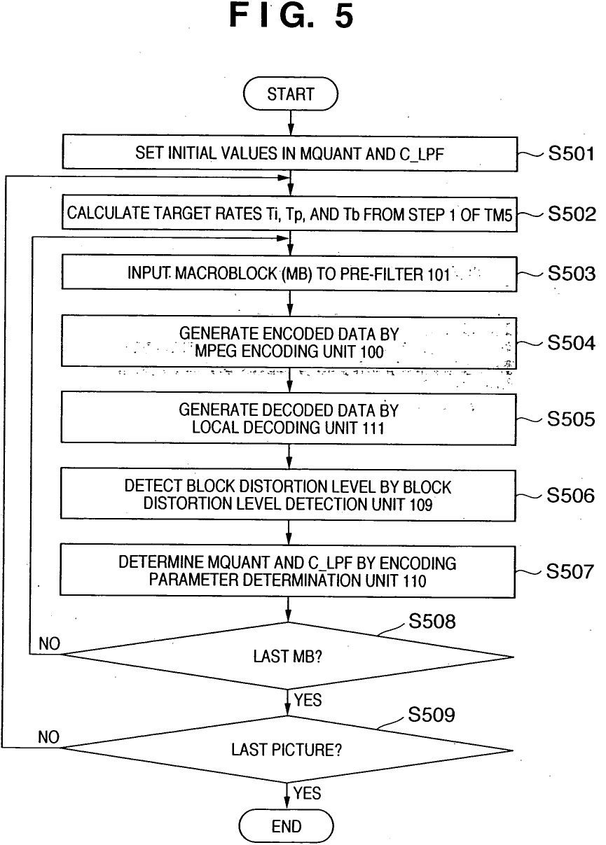

The moving image encoding apparatus 200 further comprises a block distortion level calculation unit 109 and encoding parameter determination unit 110. The encoding parameter determination unit 110 makes a calculation for determining a quantization scale MQUANT for respective macroblocks (MB), for respective pictures, or a plurality of number of times in one picture, on the basis of an image distortion level calculated by the block distortion level calculation unit 109. The flow of the moving image encoding process will be described in detail hereinafter with reference to the block diagram of FIG. 1 and the flowchart of FIG. 5.

<Overall Operation Flow>

FIG. 5 is a flowchart for explaining the process in the encoding parameter determination unit shown in FIG. 1. In step S501, initial values of MQUANT as a quantization scale (Q-scale value) and filter coefficient values (C_LPF) are set so as to use STEP 1 of the aforementioned TM5 algorithm.

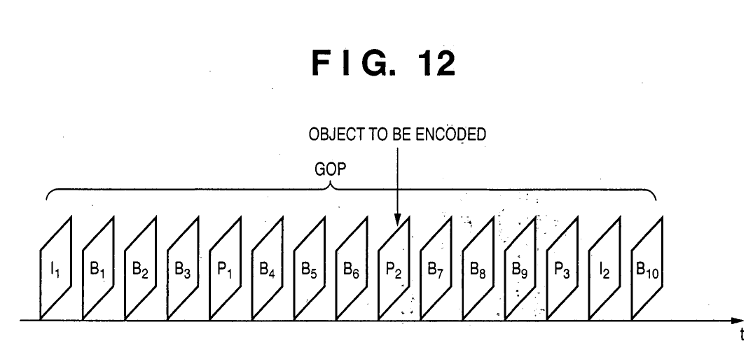

The flow advances to step S502 to calculate target rates Ti, Tp, and Tb for respective picture types (I—, P—, and B-pictures) according to equations (3). In the calculations of the target rates in this step, the target rate of the next picture to be encoded is set. FIG. 12 shows an example of pictures to be encoded, and images of respective picture types (I—, P—, and B-pictures) are respectively expressed by Xi, Xp, and Xb. If P₂-picture that forms the current GOP is set as the next picture to be encoded, the target rate for this picture is calculated.

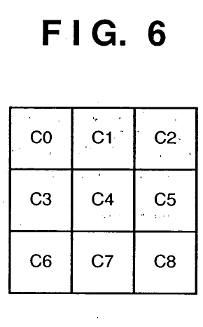

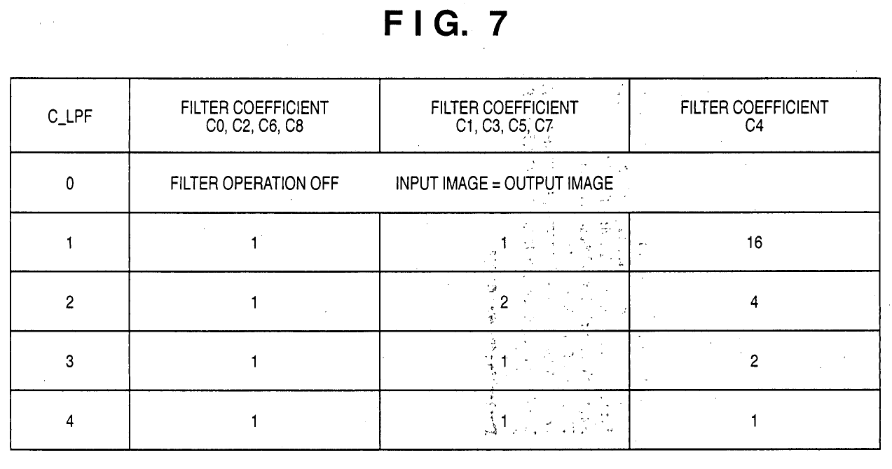

The flow advances to step S503 to input macroblocks (MB in FIG. 1), thus executing a spatial filter process. As an implementation method of a pre-filter 101, a spatial filter of a 3×3 square matrix, as shown in, e.g., FIG. 6, may be used. FIG. 7 shows the relationship between the C_LPF values and filter coefficients of the 3×3 square matrix in this case. When C_LPF=0, the filter operation is OFF, and an input image (MB)=an output image. In the example of the filter coefficients in FIG. 7, the cutoff frequency becomes lower with increasing C_LPF value. By changing the filter coefficients that define the characteristics of the pre-filter 101, the spatial filtering process for input macroblocks can be controlled to match a predetermined photographing mode. For example, when the encoding parameter determination unit 110 determines based on the calculated block distortion level and deviation between the target rate and the rate accumulated so far that block distortion is generated, it sets the pass band of the characteristics of the pre-filter 101 to be a lower-frequency region than the current one.

Note that input macroblocks (MB) before encoding undergo a spatial filter process to calculate block distortion calculations (to be described later), and are input to the block distortion level calculation unit 109. The process in the block distortion level calculation unit 109 will be described later.

In step S504, the MPEG encoding unit 100 generates variable-length encoded data (105) by quantizing macroblocks that have undergone discrete cosine transformation (103) using the quantization scale (MQUANT) value set as an initial value in step S501. Since the MPEG encoding unit 100 can be implemented by processes complying with the MPEG encoding standard, it includes units associated with motion prediction (102) and motion compensation (108), and a detailed description of these units will be omitted.

The flow advances to step S505, and the encoded data generated by the process in step S504 is input to a local decoding unit 111, which applies an inverse transformation process using an IQTZ 106 and IDCT 107 to generate decoded data. Since the local decoding unit 111 can be implemented by processes complying with the MPEG encoding standard, a detailed description of respective units will be omitted.

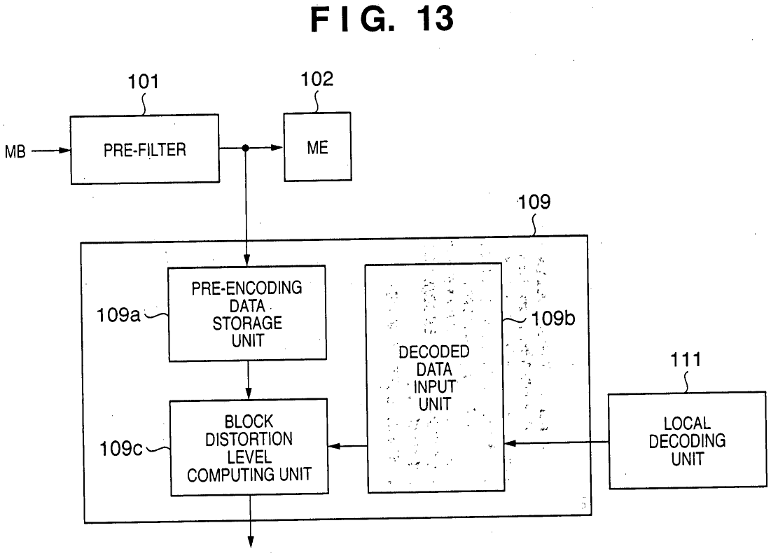

FIG. 13 is a block diagram showing the arrangement of the block distortion level calculation unit 109. In step S506, the block distortion level calculation unit 109 compares macroblocks before encoding (in step S503, macroblocks after the spatial filter process are stored in a pre-encoding data storage unit 109a of the block distortion level calculation unit 109) with macroblocks which are input via a decoded data input unit 109b and have been decoded by the local decoding unit 111, and a block distortion level computing unit 109c computes a block distortion level as a parameter used to evaluate image distortion produced by the MPEG process. As block distortion level calculation methods, for example, the following two methods can be used.

<Method 1>

Method 1 calculates the PSNR (Peak Signal to Noise Ratio) between two images before encoding and after decoding. Let Pj be the luminance component of an input image to the MPEG encoding unit 100, and Rj be the luminance component of an output image from the local decoding unit 111. Then, the PNSR can be calculated by:
SUM=Σ(Pj−Rj)² (j=0 to 255)
PSNR=20×log 10(255/sqrt(SUM/256)) (14)

By evaluating the PSNR calculated using equations (14), the image distortion level between the input image and output image can be relatively calculated.

<Method 2>

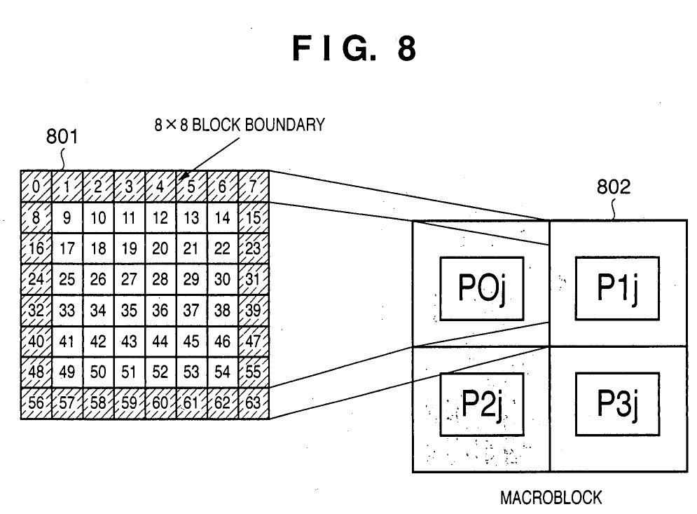

Method 2 divides two images before encoding and after decoding into 8×8 blocks, and executes difference-sum calculations given by equation (15) for respective pixels of the boundary of each 8×8 block. FIG. 8 shows an example of a macroblock (802 in FIG. 8, and boundary pixels (indicated by hatching (801 in FIG. 8)) of an 8×8 pixel block which forms that macroblock. The difference sum (BN) between the luminance components (P0j, P1j, P2j, P3j) of an input image to the MPEG encoding unit 100 and luminance components (R0j, R1j, R2j, R3j) of an output image from the local decoding unit 111 can be calculated for each boundary pixels of the four 8×8 blocks that form the macroblock using:
BN=Σ(P0j−R0j)+Σ(P1j−R1j)+Σ(P2j−R2j)+Σ(P3j−R3j) (15)
(j assumes each of hatched boundary pixel numbers in 801 of FIG. 8)

The block distortion level computing unit 109c can compute the block distortion level by one of methods 1 and 2 above.

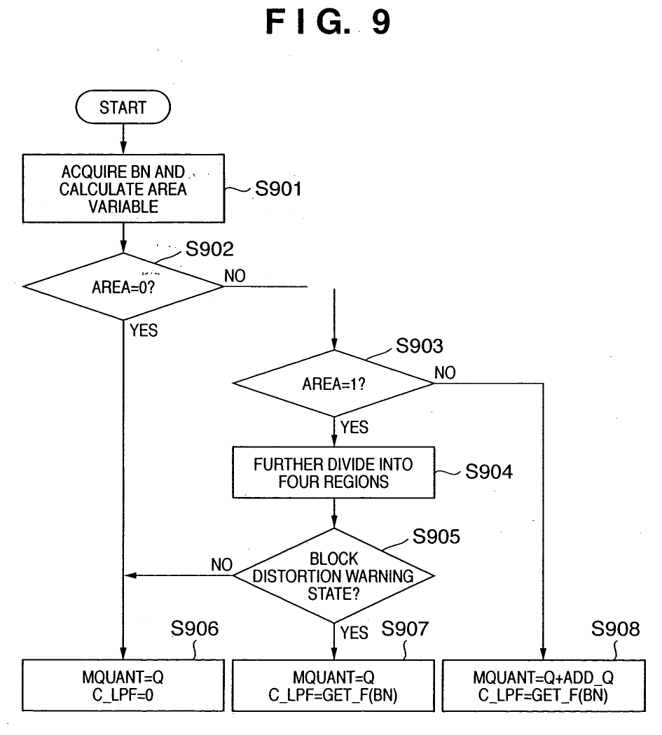

The description will revert to the flowchart of FIG. 5. In step S507, the filter coefficient value (C_LPF) and Q-scale value (MQUANT) to be used for the next macroblock are determined on the basis of the block distortion level (BN) calculated by equation (15) and the rate output from a VLC (variable-length coder) 105 in the MPEG encoding unit 100. This determination process is executed by the encoding parameter determination unit 110 of the moving image encoding apparatus 200, and will be described in detail later using FIG. 9 to FIGS. 11A and 11B.

The processes from steps S502 to S507 are repeated for all macroblocks in a picture (S508, S509), thus implementing rate control. The aforementioned processes may be set to be repeated for respective macroblocks (MG), for respective pictures, or a plurality of number of times in one picture.

<Operation of Encoding Parameter Determination Means>

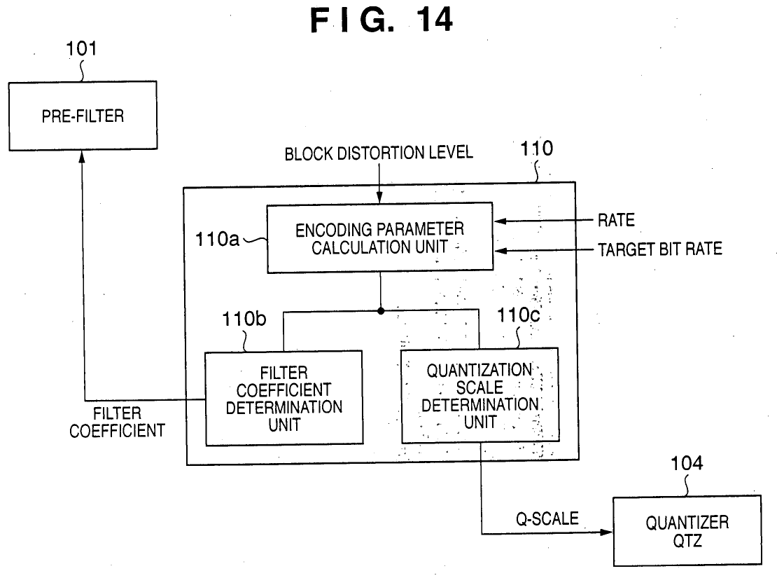

The flow of the process in step S507 in FIG. 5 will be described below using the flowchart of FIG. 9. The encoding parameter determination unit 110 that executes step S507 has an encoding parameter calculation unit 110a, filter coefficient determination unit 110b, and quantization scale determination unit 110c, as shown in FIG. 14. The encoding parameter calculation unit 110a receives the computation result of the block distortion level, rate, and target bit rate as input values, and calculates an encoding parameter used in moving image encoding. Based on this calculation result, the filter coefficient determination unit 110b and quantization scale determination unit 110c respectively determine the filter coefficients (C_LPF) to be set in the pre-filter 101 and the quantization scale (Q-scale) MQUANT to be set in the quantizer (QTZ) 104.

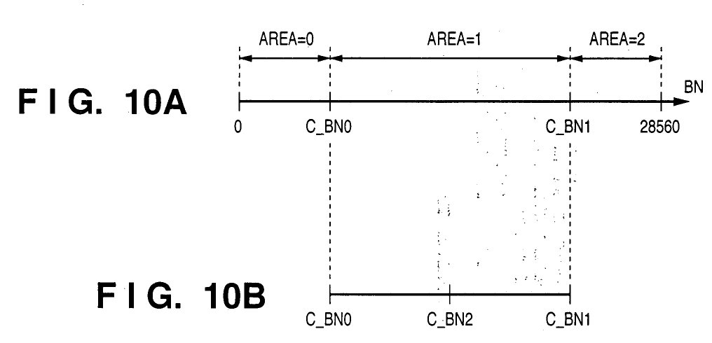

In step S901 in FIG. 9, the encoding parameter calculation unit 110a acquires AREA variables (0 to 2) corresponding to three areas shown in FIG. 10A on the basis of the block distortion level value (BN). Note that the block distortion level (BN) value assumes a value ranging from 0 to 28560 from equation (15) if one pixel is expressed by 8 bits. C_BN0 and C_BN1 in FIGS. 10A and 10B are setting values used to divide the distortion level (BN) into three AREAs. The encoding parameter calculation unit 110a compares setting values and the distortion level (BN) with the distortion level (BN) to obtain the correspondence between the distortion level (BN) and AREA by:

| | |
|---|---|
| IF (BN < C_BN0) THEN | (S1) |
| AREA = 0 | (S2) |
| ELSE IF (BN < C_BN1) THEN | (S3) |
| AREA = 1 | (S4) |
| ELSE | (S5) |
| AREA = 2 for (C_BN1 ≧ C_BN0) | (S6) |

At this time, the reference values C_BN0 and C_BN1 used to divide AREA are set in advance before an input image is input to the moving image encoding apparatus 200 according to the embodiment of the present invention. The encoding parameter calculation unit 110a executes the following process in accordance with the obtained AREA.

If AREA=0 in step S902 (S902—YES), the flow advances to step S906. At this time, the filter coefficient determination unit 110b and quantization scale determination unit 110c determine the spatial filter process by the pre-filter 101 and the quantization scale MQUANT by directly using the quantization scale reference value Qj (see equation (6)) calculated in STEP 2 in the TM5 algorithm, since the immediately preceding macroblock has a small block distortion level value BN.

If AREA=1 in step S903 (S903—YES), the flow advances to step S904 to further divide AREA1 into two areas by a parameter C_BN2 (see FIG. 10B). The encoding parameter calculation unit 110a predicts whether or not visually conspicuous block distortion is produced by the following method (S7 to S14).

| | |
|---|---|
| IF (BN < C_BN2) THEN | (S7) |
| WARN_BN = 0 | (S8) |
| ELSE | (S9) |
| IF (WARN_BN_COUNT > C_BN_COUNT) THEN | (S10) |
| WARN_BN = 1 | (S11) |
| ELSE | (S12) |
| WARN_BN = 0 | (S13) |
| (C_BN1 ≧ C_BN2 ≧ C_BN0) | (S14) |

Note that the parameter C_BN2 used to further divide AREA=1 into two areas is set in advance as in the parameters C_BN0 and C_BN1. Also, WARN BN is a parameter used to specify that block distortion is large and a warning state is set. In step S905 in FIG. 9, the encoding parameter calculation unit 110a checks this parameter value.

If WARN_BN=0 (S905—NO), the same process as that executed when AREA=0 is executed (S906); if WARN_BN=1, it is checked if the same process as that executed when AREA=0 is executed.

Let “WARN_BN_COUNT” be the number of BN values in one horizontal scan for a previous macroblock, which are larger than the C_BN2 value. Then, it is checked if WARN_BN_COUNT is larger than the constant C_BN_COUNT which is set in advance. If WARN_BN=0 (S905—NO), the flow advances to step S906; if WARN_BN=1 (S905—YES), it is determined that block distortion is large and a warning state is set, and the coefficients are set to change the filter coefficients of the pre-filter 101 (S907). In step S907, the process for changing the values of the filter coefficients (C_LPF) to decrease block distortion is executed, and the quantization scale MQUANT) directly uses the value of the quantization reference value Qj as in step S906.

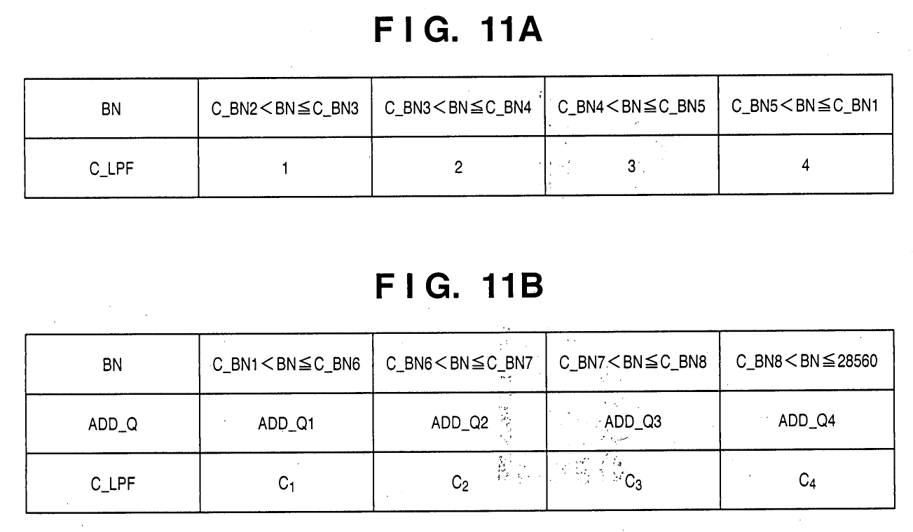

The filter coefficient determination unit 110b obtains the relationship between the block distortion level (BN) and parameters C_BNi (i=2 to 5) on the basis of a function GET_F(BN) used to calculate the filter coefficients (C_LPF) and a data table shown in FIG. 11A, thus specifying the corresponding filter coefficients (C_LPF). The specified filter coefficients (C_LPF) are set in the pre-filter 101 (S907).

If block distortion level (BN)≦C_BN2, the same process as in step S906 is executed. In this case, the filter coefficient C_LPF=0 is set.

If C_BN1<block distortion level (BN), the same process as that of AREA2 in step S908 (to be described later) is executed.

Since it is checked if the block distortion level is to be warned, generation of visually conspicuous block distortion can be avoided in advance.

On the other hand, if the block distortion level (BN) falls within AREA=2 in the process of step S903 (S903—NO), the flow advances to step S908. Since this AREA corresponds to an area where the block distortion level (BN) is large, the quantization scale (MQUANT) is changed in addition to the setting process of the filter coefficients used to change the spatial filter process. In the setting process of the filter coefficients, as in the process in step S907, the filter coefficient determination unit 110b specifies filter coefficients (C_LPF)=Ci (i=1 to 4) in accordance with the corresponding block distortion level (BN) using a data table shown in FIG. 11B, and sets them in the pre-filter 101. Note that the filter coefficients to be set are set to realize the characteristics of the pass band of a lower-frequency region with increasing calculated block distortion level.

The quantization scale determination unit 110c further specifies a constant ADD_Qi (i=1 to 4) shown in FIG. 11B for the quantization scale reference value Qj calculated in STEP 2 of the TM5 algorithm in accordance with the block distortion level (BN). The specified constant ADD_Qi is added to the quantization scale reference value Qj and the sum is set in the quantizer (QTZ) 104. Note that the quantization scale reference value Qj is given by equations (4) and (5) in STEP 2 in the TM5 algorithm, and is computed on the basis of the target rate (target bit rate) and the rate output from the VLC 105 in the MPEG encoding unit 100. When the value (ADD_Qi (i=1 to 4)) according to the block distortion level is added to this reference value Qj, the quantization scale is changed, and block distortion information is reflected in rate control for the next picture.

Note that parameters C_BN3 to C_BN8 in FIGS. 11A and 11B are set in advance as in parameters C_BN0 and C_BN1 used to divide AREA. In this way, if an area where the block distortion level is large is reached, the filter coefficients and quantization scale are changed to effectively avoid generation of visually conspicuous block distortion.

As described above, according to this embodiment, upon executing the rate control using the pre-filter, at least one of the filter coefficients and quantization scale is changed on the basis of the block distortion level calculated for respective blocks until the immediately preceding block, thereby implementing filter control and rate control for obtaining a high-quality decoded image which reflects the human visual characteristics and is free from noise.

### Second Embodiment

The second embodiment will exemplify a case wherein the present invention is applied to a general lossy encoding scheme entailing encoding distortion without limiting an encoding scheme. The third embodiment to be described later will exemplify a case wherein the present invention is applied to an MPEG encoding scheme.

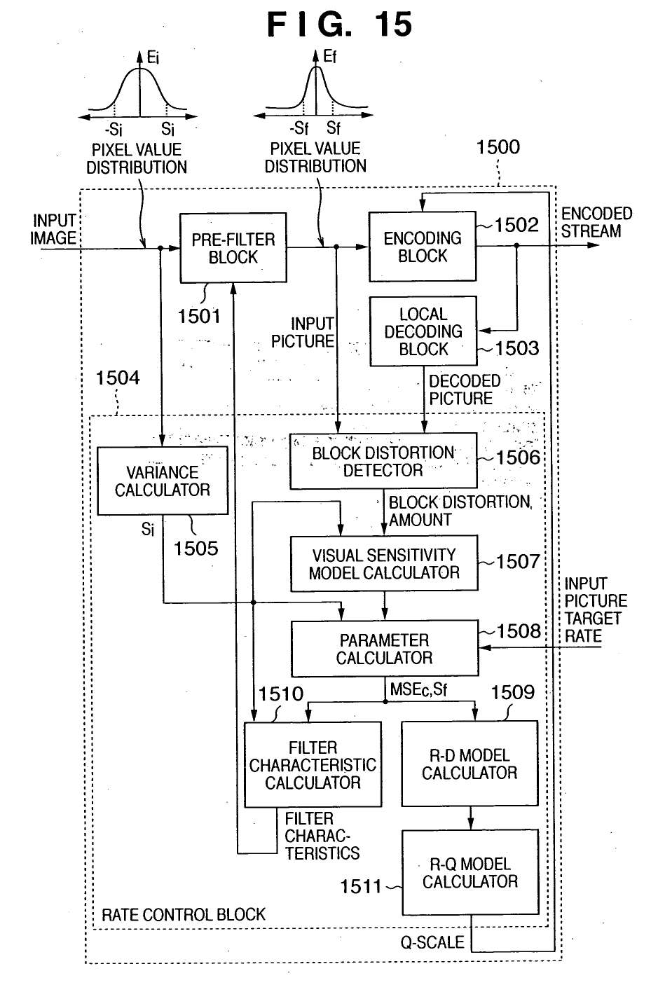

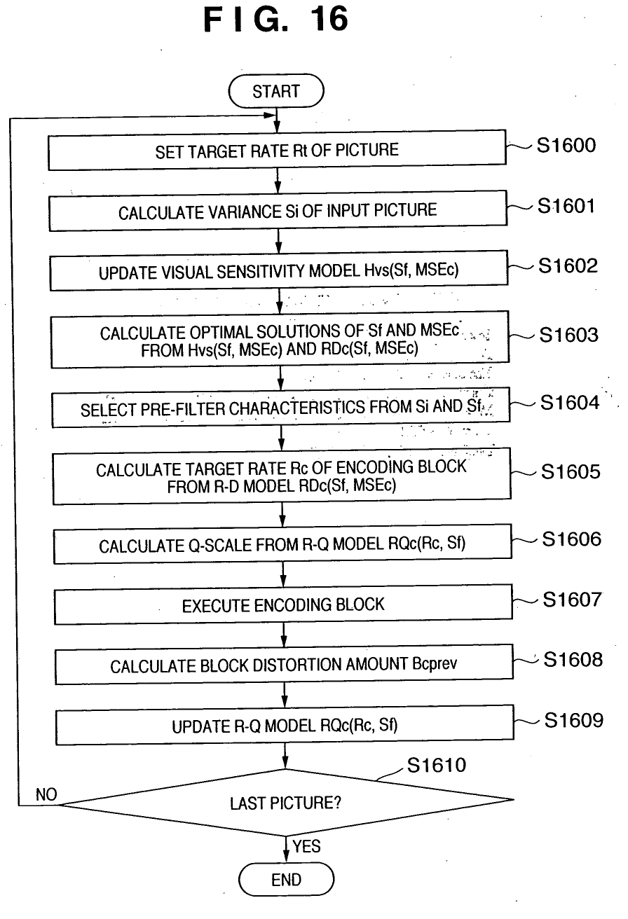

FIG. 15 is a block diagram showing the arrangement of a moving image encoding apparatus according to the second embodiment of the present invention. FIG. 16 is a flowchart showing the process to be executed by the moving image encoding apparatus according to the second embodiment of the present invention.

Details of the operation of the moving image encoding apparatus according to the second embodiment will be described below using FIGS. 15 and 16.

Assume that the weighting parameter of the quantization process in the moving image encoding apparatus is a Q-scale.

As shown in FIG. 15, a moving image encoding apparatus 1500 roughly includes a pre-filter block 1501, encoding block 1502, local decoding block 1503, and rate control block 1504. These blocks may be implemented by hardware or some or all of the blocks may be implemented as software by control using a CPU, RAM, and ROM.

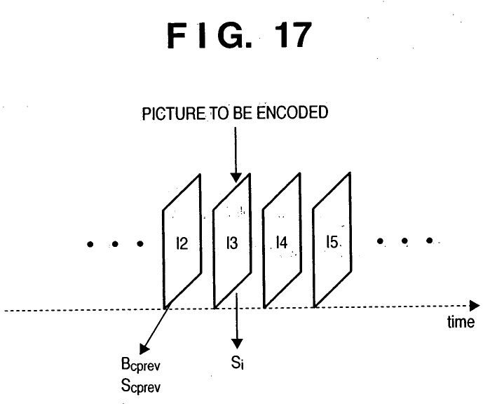

At the beginning of the description of the operation of the moving image encoding apparatus 1500, an encoding process is complete up to picture I2 at the current timing, and the encoding process of picture I3 will be executed next, as shown in FIG. 17.

In step S1600 in FIG. 16, a target rate Rₜ of picture I3 is set by an external block (not shown). The method of calculating Rₜ does not depend on the present invention, and corresponds to the process of STEP 1 of the TM5 algorithm if, for example, the CBR scheme in the prior art is adopted.

The moving image encoding apparatus 1500 does not directly calculate the Q scale of the encoding block 1502 from the set target rate Rₜ, but optimally divides an encoding distortion amount assumed from the target rate Rₜ to the pre-filter unit 1501 and encoding block 1502 using a visual sensitivity model calculator 1507 and R-D model calculator 1509.

In step S1601, a variance calculator 1505 calculates a variance Sᵢ of picture I3. For example, the variance Sᵢ is calculated as follows.

If the picture of interest has a coordinate system (x, y), a picture size of M×N, and an average AVE, the variance Sᵢ of that picture is calculated by:

$${S}_{i} = \frac{{\sum }_{y = 0}^{N - 1} {\sum }_{x = 0}^{M - 1} {( I ( x , y ) - AVE )}^{2}}{MN} \qquad ( 16 )$$

An R-D model (R-D specifying formula) and visual sensitivity model (visual sensitivity evaluation formula) of the encoding block 1502 used in steps S1603 and S1604 will be explained below.

An R-D model R_{c}(S_{f}, MSE_{c}) of the encoding block 1502 applied in the second embodiment is calculated by:

$${R}_{c} ( {S}_{f} , {MSE}_{c} ) = {Θ}_{c} log ( \frac{{S}_{f}}{{MSE}_{c}} {I}_{c} ) \qquad ( 17 )$$

where I_{c} and Θ_{c} are constants. If I_{c}=1 and Θ_{c}=0.5, this equation is a known formula that represents the relationship between the rate and encoding distortion amount, which is known as the Rate Distortion theory as the branch of the information theory.

S_{f} is the variance of an input picture of the encoding block 1502, and corresponds to that of an output picture of the pre-filter block 1501. The variance S_{f} is a variable that changes in accordance with the variance Sᵢ of the input picture of the moving image encoding apparatus 1500 of the second embodiment, and the filter characteristics of the pre-filter block 1501.

MSE_{c} is an encoding distortion amount produced by the encoding block 1502. MSE_{c} is a variable corresponding to the square sum of the difference between the input picture of the encoding block 1502 and the output picture of the local decoding block 1503.

I_{c} and Θ_{c} are defined as parameters depending on the encoding scheme of the encoding block 1502. Since the second embodiment assumes a case wherein the encoding scheme of the encoding block 1502 is not limited, I_{c}=1 and Θ_{c}=0.5 are applied.

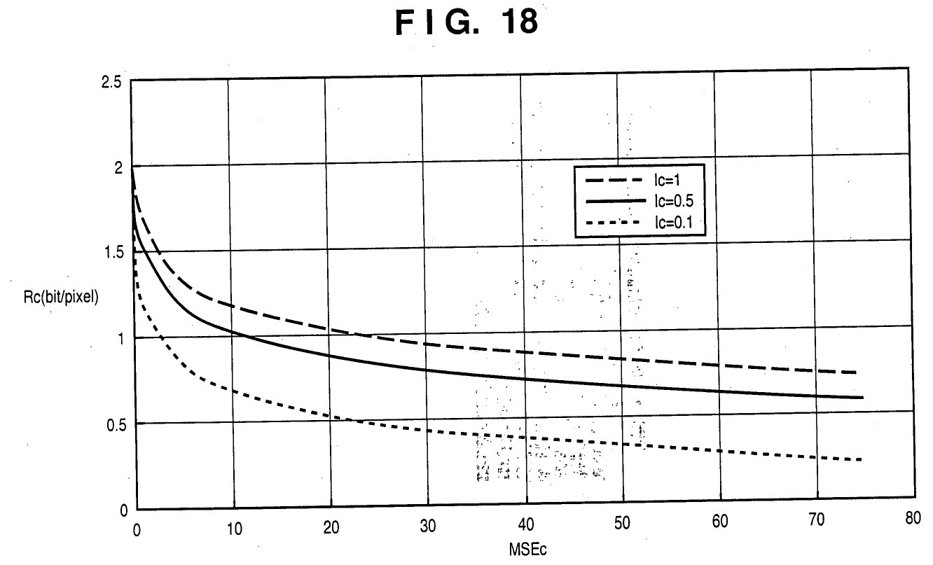

Note that FIG. 18 shows, as the graph showing the characteristics of equation (17), the relationship between the rate R_{c} and encoding distortion amount MSE_{c} when S_{f}=2300, I_{c}=1, and Θ_{c}=0.5.

In the second embodiment, a visual sensitivity model Hᵥₛ(S_{f}, MSE_{c}) used in step S1603 is defined as:

$${H}_{vs} ( {S}_{f} , {MSE}_{c} ) = {MSE}_{f} ( {S}_{f} ) + {MSE}_{c} + \frac{{S}_{f}}{{S}_{cprev}} {B}_{cprev} \qquad ( 18 )$$

where MSE_{f} is the filter distortion amount produced by the pre-filter block 1501, B_{cprev} is the block distortion amount detected by a block distortion detector 1506 upon an encoding process of the immediately preceding picture, and S_{cprev} is the variance S_{f} of the immediately preceding input picture of the encoding block 1502.

Furthermore, the filter distortion amount MSE_{f} in equation (18) is defined as:

$${MSE}_{f} ( {S}_{f} ) = α ( \frac{{S}_{i}}{{S}_{f}} - 1 ) \qquad ( 19 )$$

where α is a constant depending on the filter type of the pre-filter block 1501.

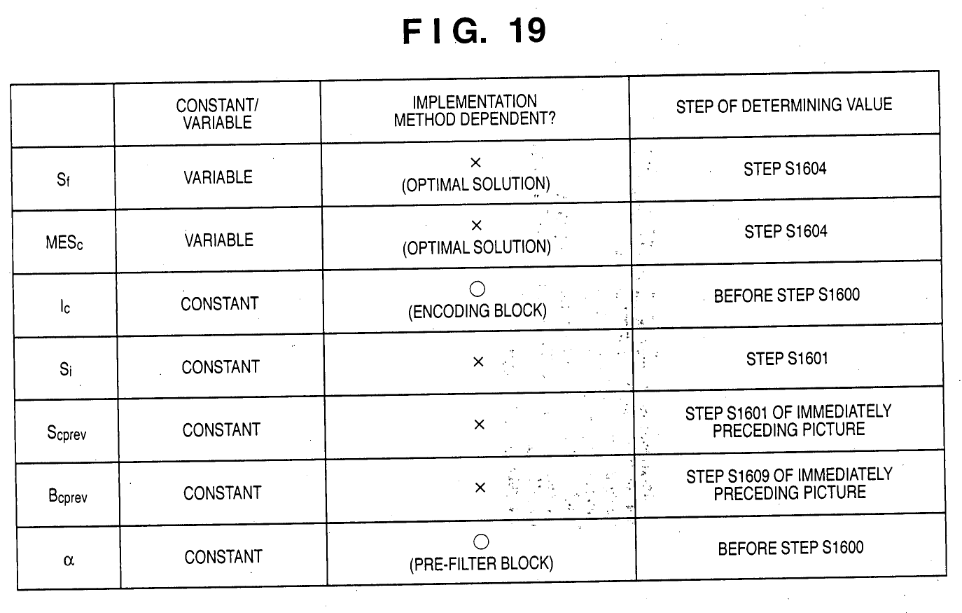

Note that FIG. 19 shows a list of variables and constants used in equations (17) to (19).

Features of the visual sensitivity model Hᵥₛ(S_{f}, MSE_{c}) given by equations (18) and (19) used in the second embodiment will be described below.

Feature 1: Since not only the encoding distortion amount MSE_{c} produced by the encoding block 1502 but also the filter distortion amount MSE_{f}(S_{f}) produced by the pre-filter block 1501 are taken into consideration, the overall distortion amount of the moving image encoding apparatus 1500 can be evaluated, and high-precision image quality control can be achieved.

Feature 2: Since the block distortion amount B_{cprev} is added as an evaluation amount, image quality evaluation approximate to the human visual sensitivity can be made.

The visual sensitivity model Hᵥₛ(S_{f}, MSE_{c}) is calculated from the variance Sᵢ of the input picture of the moving image encoding apparatus 1500, and the variance S_{cprev} of the immediately preceding input picture and the block distortion amount B_{cprev} of the immediately preceding picture of the encoding block 1502 using equations (18) and (19) in step S1602.

The method of calculating the variance S_{f} and encoding distortion amount MSE_{c} in a parameter calculator 1508 in step S1603 will be explained below.

In the second embodiment, the variance S_{f} and encoding distortion amount MSE_{c} that optimize the relationship between the two models, i.e., the visual sensitivity model Hᵥₛ(S_{f}, MSE_{c}) and R-D model R_{c}(S_{f}, MSE_{c}), are calculated using the Lagrangian method with undetermined multipliers under the constraint conditions of the target rate of the picture input to the moving image encoding apparatus 1500.

That is, let Rₜ be the target rate of the picture input to the moving image encoding apparatus 1500. Then, the constraint conditional formula is given by:

[Constraint Conditional Formula]
R(S_{f},MSE_{c})=Rₜ−R_{c}(S_{f},MSE_{c})=0 (20)

Furthermore, if an undetermined multiplier is defined by λ, we have:
J(S_{f},MSE_{c})=λR(S_{f}, MSE_{c})+Hᵥₛ(S_{f},MSE_{c}) (21)

The following equation is defined as a required conditional formula:
[Required Conditional Formula]

$$\begin{matrix}\frac{\partial J}{\partial {S}_{f}} = λ \frac{\partial R}{\partial {S}_{f}} + \frac{\partial {H}_{vs}}{\partial {S}_{f}} = 0 \\ \frac{\partial J}{\partial {MSE}_{c}} = λ \frac{\partial R}{\partial {MSE}_{c}} + \frac{\partial {H}_{vs}}{\partial {MSE}_{c}} = 0\end{matrix} \qquad ( 22 )$$

Therefore, from equations (20) and (22), in order to calculate optimal solutions of the variance S_{f} and encoding distortion amount MSE_{c}, the following equations are calculated in step S1603:

$${S}_{f} = {\{ ( \frac{α {S}_{i}}{[ \frac{{I}_{c}}{e \frac{{R}_{t}}{{e}_{c}}} + \frac{{B}_{c}}{{S}_{cprev}} ]} \} )}^{\frac{1}{2}} \\ {MSE}_{c} = \frac{{I}_{c}}{e \frac{{R}_{t}}{{e}_{c}}} {\{ \frac{α {S}_{i}}{[ \frac{{I}_{c}}{e \frac{{R}_{t}}{{e}_{c}}} + \frac{{B}_{c}}{{S}_{cprev}} ]} \}}^{\frac{1}{2}} \qquad ( 23 )$$

for I_{c}=1 and Θ_{c}=0.5 in the second embodiment where α is a coefficient depending on the type of filter that forms the pre-filter block 1501, and is determined in advance upon configuring the moving image encoding apparatus 1500.

In step S1604, a filter characteristic calculator 1510 determines the filter characteristics of the pre-filter 1501. In the second embodiment, the filter characteristics are selected using changes in variances of the input and output pictures of the pre-filter block 1501.

Note that the variance Sᵢ of the input picture and the variance S_{f} of the output picture have already been calculated in steps S1601 and S1603, respectively.

One of filter coefficients, which has most approximate characteristics, is selected from the variance characteristics of the input and output pictures of the pre-filter block 1501 in accordance with the relationship between these two variances Sᵢ and S_{f} and changes of a plurality of filter coefficients determined in advance.

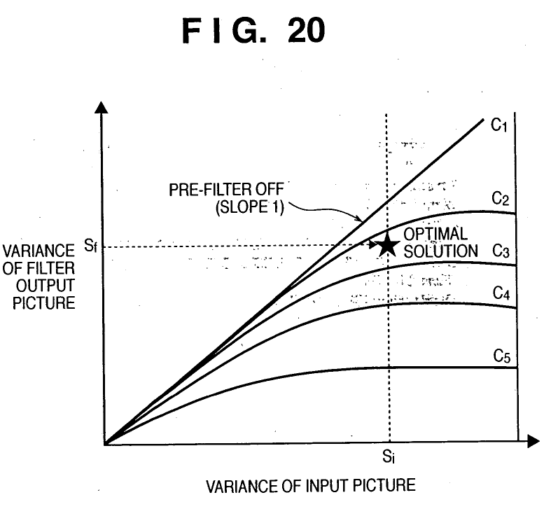

FIG. 20 indicates that a filter coefficient C2 which is most approximate to the relationship between the calculated variances Sᵢ and S_{f} is selected from five curves that represent the variance characteristics of the input and output pictures of the pre-filter block 1501 corresponding to filter coefficients C1 to C5, which are determined in advance.

The pre-filter block 1501 changes the filter coefficient to attain the corresponding filter characteristics by receiving one of parameters C1 to C5 from the filter coefficient calculator 1510.

In step S1605, the R-D model calculator 1509 calculates a target rate R_{c} of the encoding block 1502 from the R-D model R_{c}(S_{f}, MSE_{c}) using the encoding distortion amount MSE_{c} and variance S_{f} obtained from equations (23).

This target rate R_{c} is calculated by substituting the corresponding encoding distortion amount MSE_{c} and variance S_{f} in the R-D model R_{c}(S_{f}, MSE_{c}) given by equation (17).

In step S1606, the Q-scale of the encoding block 1502 is calculated using the target rate R_{c} calculated in step S1605. The Q-scale is calculated using an R-Q model of the encoding block 1502. In the second embodiment, an R-Q model RQ_{c}(R_{c}, S_{f}) of the encoding block 1502 is expressed by:

$${R}_{c} = {β}_{c} \frac{{S}_{f}}{{Q}_{c}} \qquad ( 24 )$$

where R_{c} is the target rate R_{c} calculated in step S1605, and S_{f} is the variance of the input picture of the encoding block 1502 calculated in step S1603.

Also, β_{c} is a constant, which is obtained by substituting the values R_{c}, Sᵢ, and Q_{c} used for the immediately preceding picture in equation (24) again. In the second embodiment, in order to improve the calculation precision of the Q-scale, the R-Q model RQ_{c}(R_{c}, S_{f}) is updated in step S1609 using:

$${β}_{c} = \frac{{\sum }_{k = 1}^{n} {R}_{ck} {\sum }_{k = 1}^{n} {Q}_{ck}}{{\sum }_{k = 1}^{n} {S}_{fk}} \qquad ( 25 )$$

where n is the number of old pictures to be reflected to the R-Q model RQ_{c}(R_{c}, S_{f}).

Upon completion of the processes from step S1600 to step S1606, the processes of the pre-filter block 1501 and encoding block 1502 are executed in step S1607.

Parallel to the encoding process of the encoding block 1502, the block distortion detector 1506 detects the block distortion amount B_{cprev} in step S1608. The block distortion amount B_{cprev} is detected using the input picture of the encoding block 1502 and the output picture of the local decoding block 1503.

It is known that a person is very sensitive to block distortion as the human visual sensitivity. This block distortion is produced since orthogonal transformation and quantization processes are applied for respective 8×8 square blocks.

The detection method of the block distortion amount B_{cprev} does not depend on the present invention, but can be freely implemented. Even when the block distortion is detected from an identical picture, different block distortion amounts B_{cprev} are detected depending on the detection methods.

However, such difference can be absorbed by multiplying B_{cprev} by a constant in consideration of the visual model Hᵥₛ(S_{f}, MSE_{c}) given by equation (18). This constant is a value uniquely determined upon configuring the moving image encoding apparatus 1500 of the second embodiment, as long as the detection method of the block distortion detector 1506 is determined.

In the second embodiment, as the detection method of the block distortion detector 1506, block distortion amount B_{cprev} is calculated using the ratio between a difference square sum MSE_{blk} of 8×8 block boundaries and difference square sum MSEₐₗₗ of the entire picture.

Let x_size be the number of pixels in the horizontal direction and y_size be the number of pixels in the vertical direction both of the input picture of the encoding block 1502. Let CIN(J, I) be the pixel value of the input picture of the encoding block 1502, which has a horizontal coordinate position J and vertical coordinate position I, and COUT(J, I) be the pixel value of the output picture of the local decoding block 1503. Then, the block distortion amount B_{cprev} is calculated using:

for (I = 0; I < y_size − 1; I++){
for (J = 0; J < x_size − 1; J++){

if (J%8 == 7){

EDGEᵢₙ = ABS(CIN(J,I) − CIN(J,I+1));
EDGEₒᵤₜ = ABS(COUT(J,I) − COUT(J,I+1));
MSE_{blk}++ = POWER(EDGEᵢₙ − EDGEₒᵤₜ));}

else{

if(I%8 == 7){

EDGEᵢₙ = ABS(CIN(J,I) − CIN(J+1,I));
EDGEₒᵤₜ = ABS(COUT(J,I) − COUT(J+1,I));
MSE_{blk}++ = POWER(EDGEᵢₙ − EDGEₒᵤₜ));}

}}

B_{cprev} = λMSE_{blk}/MSEₐₗₗ;

where MSEₐₗₗ is the difference square sum of CIN(J, I) and COUT(J, I) of the entire picture, and λ is a constant depending on the detection method of the block distortion detector 1506.

As described above, according to the second embodiment, since the processes in steps S1600 to S1609 are repeated every time a picture is input to the moving image encoding apparatus 1500, the pre-filter block 1501 and encoding block 1502 can be controlled in consideration of the degree of deterioration of image quality and the human visual characteristics.

Hence, encoded moving image data which has an optimal rate and encoding distortion amount can be obtained under the condition of the allocated target rate.

### Third Embodiment

As the third embodiment, an example in which the MPEG-4 encoding scheme is applied to an encoding block will be described in detail hereinafter.

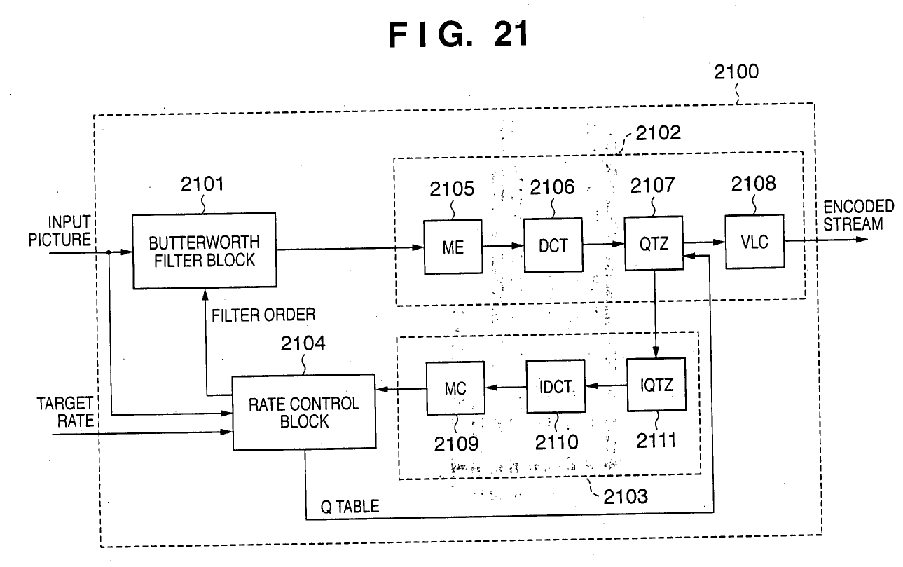

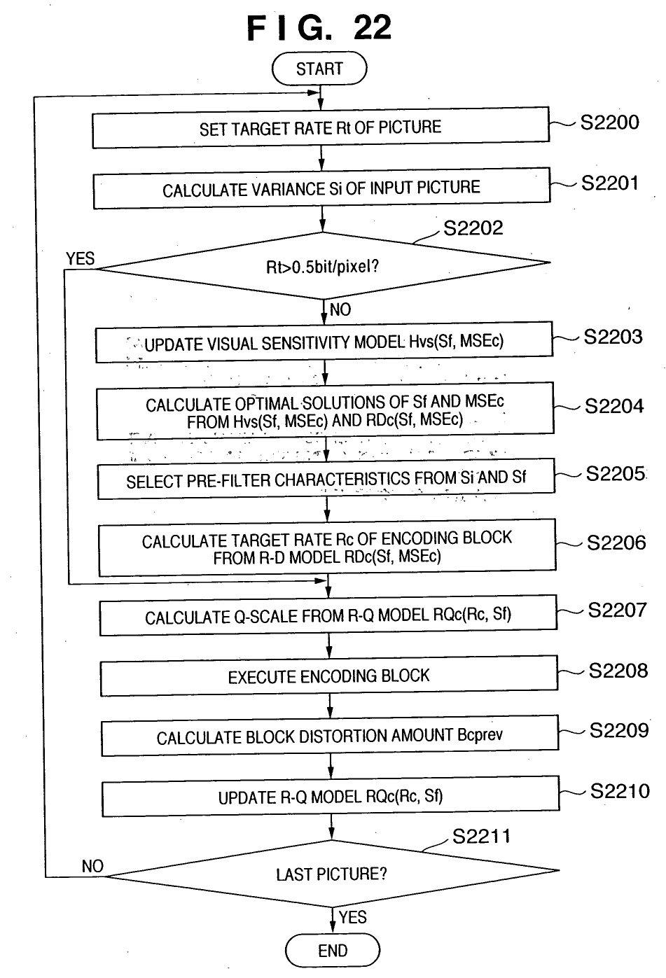

FIG. 21 is a block diagram showing the arrangement of a moving image encoding apparatus according to the third embodiment of the present invention. FIG. 22 is a flowchart showing the process to be executed by the moving image encoding apparatus according to the third embodiment of the present invention.

Respective blocks which form a moving image encoding apparatus 2100 of the third embodiment shown in FIG. 21 have the following two differences from those which form the moving image encoding apparatus 1500 of the second embodiment shown in FIG. 15.

Difference 1 of blocks: The pre-filter block 1501 shown in FIG. 15 corresponds to a Butterworth filter block 2101 in FIG. 21.

Difference 2 of blocks: The encoding block 1502 in FIG. 15 corresponds to an MPEG encoding block 2102 in FIG. 21.

Note that the internal block arrangement of a rate control block 2104 is the same as that of the rate control block 1504 in FIG. 15.

The MPEG encoding block 2102 has a motion detector (ME) 2105, DCT block 2106, quantizer (QTZ) 2107, and variable-length coder (VLC) 2108. A local MPEG decoding block 2103 has a motion compensator (MC) 2109, inverse DCT block (IDCT) 2110, and dequantizer (IQTZ) 2111.

These blocks may be implemented by hardware or some or all of the blocks may be implemented as software by control using a CPU, RAM, and ROM.

The flowchart which shows the process to be executed by the moving image encoding apparatus of the third embodiment shown in FIG. 22 has the following two differences from that which shows the process to be executed by the moving image encoding apparatus 1500 of the second embodiment shown in FIG. 15.

Difference 1 of process: An R-D model used in the processes in steps S2204 and S2206 in FIG. 22 is different from that used in steps S1603 and S1605 in FIG. 16.

Difference 2 of process: The selection method of the filter characteristics in step S2205 in FIG. 22 is different from that in step S1604 in FIG. 16.

Some processes of the overall process of the MPEG-4 encoding scheme, which correspond to the process of the moving image encoding apparatus 2100 of the third embodiment, will be explained, and the differences of the two processes will be explained in detail below.

[Corresponding Processes in Overall Process]

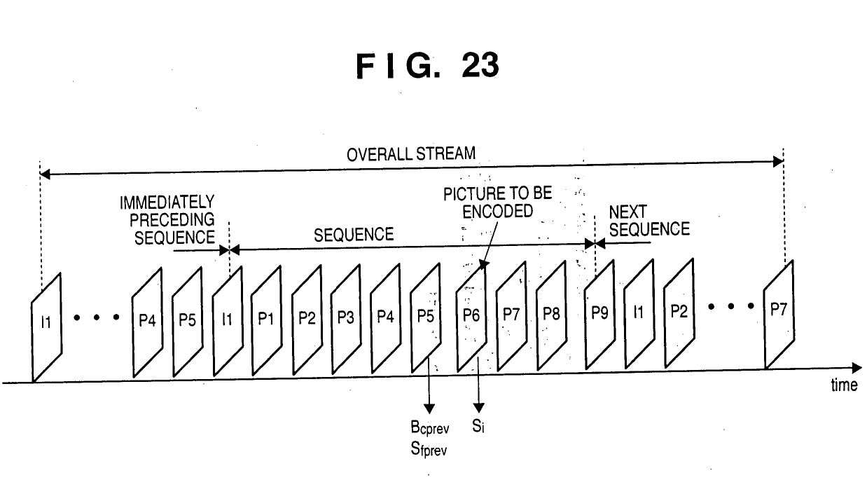

In the third embodiment, the overall stream is segmented into sequences each including a plurality of pictures, as shown in FIG. 23. Rate control handles this sequence as one unit, and respective sequences are encoded to have an identical bit rate. For example, this sequence corresponds to Group_of_VideoObjectPlane( ) in the syntax of the MPEG-4 encoding scheme.

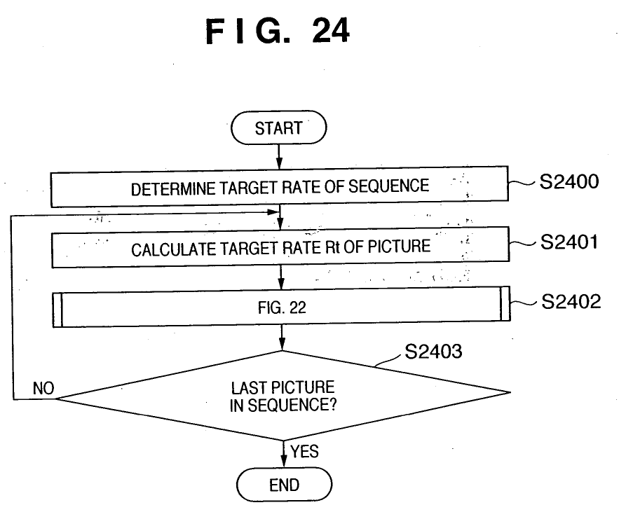

FIG. 24 is a flowchart showing the process of the MPEG-4 encoding scheme in one sequence. The number of pictures that form a sequence, and the target rate of the sequence do not depend on the present invention.

For example, assume that the target rate of the sequence corresponds to R_{gop} in equation (1) of the prior art in step S2400. In this case, equations (2) and (3) of the prior art can be used to calculate a target rate Rₜ of one picture that forms the sequence in step S2401.

After the target rate Rₜ of one picture that forms the sequence is calculated, all pictures which form the sequence are encoded by repeating the process in FIG. 22 in step S2402.

[Difference 1 of Process]

In the third embodiment, an R-D model R_{c}(S_{f}, MSE_{c}) of the MPEG encoding block 2102 is defined as in the second embodiment. Note that the picture types to be encoded by the moving image encoding apparatus 2100 of the third embodiment are two types, i.e., I— and P-pictures.

The values of the two constants I_{c} and Θ_{c} of the R-D model R_{c}(S_{f}, MSE_{c}) given by equation (17) are defined to represent the relationship between the rate R_{c} and encoding distortion amount MSE_{c} of the MPEG encoding block 2101 of the third embodiment.

Upon encoding of P-picture of the MPEG-4 encoding scheme, a difference calculation is made using correlation between neighboring pictures unlike encoding of I-picture that uses only information in the picture.

This difference calculation is implemented by two blocks, i.e., the ME 2105 that executes a motion detection process and the MC 2109 that executes a motion compensation process in FIG. 21.

That is, even when identical pictures are input to the MPEG encoding block 2102, the variance of the input picture of the DCT 2106 that performs an orthogonal transformation process differs depending on whether the current picture to be encoded is I— or P-picture, and the R-D model R_{c}(S_{f}, MSE_{c}) of the MPEG encoding block 2102 cannot be expressed.

To solve this problem, the variance S_{f} of the input picture of the DCT 2106 is calculated upon encoding either I— or P-picture, and it can be defined as the variance S_{f} in equation (17). In this case, however, a variance model that considers the processes of the MEG 2105 and MC 2109 need be defined.

In the third embodiment, two R-D models R_{c}(S_{f}, MSE_{c}) according to the picture types are defined.

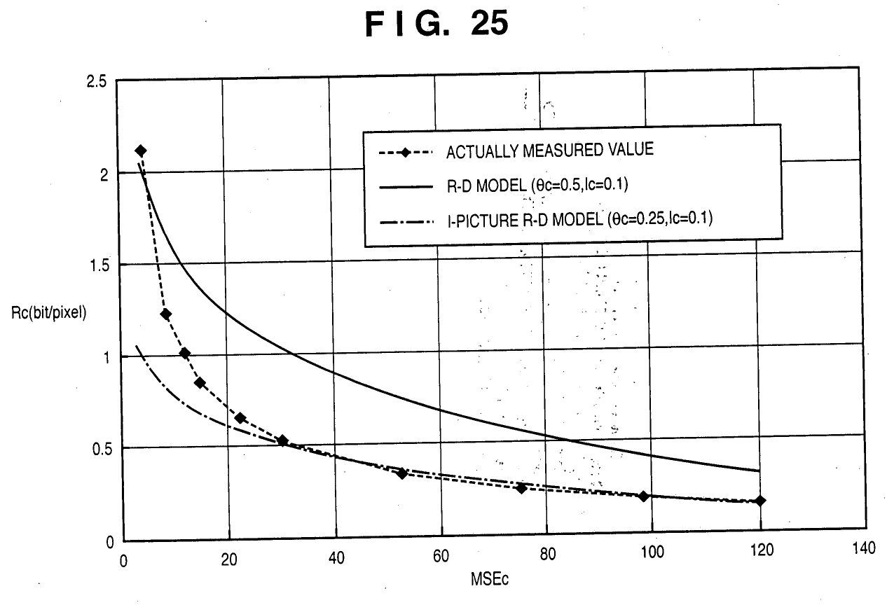

FIG. 25 shows the relationship of the rate R_{c} and encoding distortion amount MSE_{c} of an R-D model R_{ic}(S_{f}, MSE_{c}) in I-picture of the MPEG encoding block 2101.

A curve indicated by “-▴-” in FIG. 25 corresponds to an R-D model defined when the two constants I_{c} and Θ_{c} in equation (17) are set to be I_{c}=1 and Θ_{c}=0.5, and a curve indicated by “-▪-” corresponds to an I-picture R-D model R_{ic}(S_{f}, MSE_{c}) corresponding to I-picture of the MPEG encoding block 2102 of the third embodiment when I_{c}=0.1 and Θ_{c}0.25. Furthermore, a curve indicated by “-♦-” indicates the actually measured value upon encoding I-picture by the MPEG-4 encoding scheme in practice.

In FIG. 25, in a region of the rate R_{c}≧0.5, a large deviation is produced between the curve of the actually measured value and that of the I-picture R-D model R_{ic}(S_{f}, MSE_{c}).

Note that the bit rate corresponding to the rate R_{c}=0.5 corresponds to a bit rate as very high as 6.6 Mbps when the image size of the input picture of the MPEG encoding block 2102 is VGA, subsample is 4-2-0, and the frame rate is 30 fps.

When the MPEG encoding block 2102 performs encoding at such high bit rate, it rarely produces block distortion of a visually conspicuous level, and the Butterworth filter block 2101 does not require any pre-filter process which relaxes block distortion.

That is, the process for controlling the filter characteristics of the Butterworth filter block 2101 in steps S2203 to S2206 can be omitted.

Hence, if it is determined in step S2202 that the target-rate of the picture input to the moving image encoding apparatus 2100 is 0.5 bits/pixel, the flow jumps to step S2207.

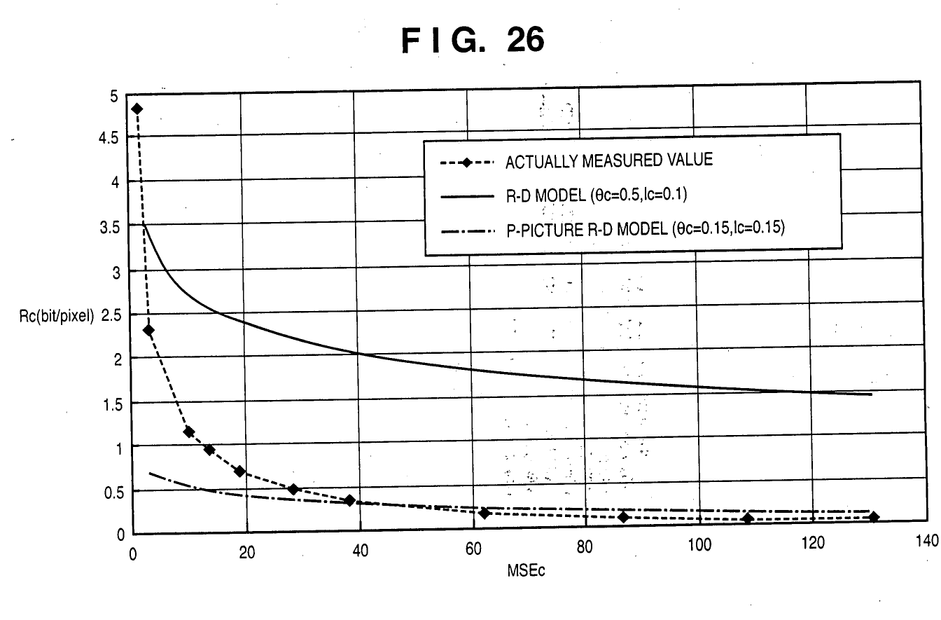

On the other hand, FIG. 26 shows the relationship of the rate R_{c} and encoding distortion amount MSE_{c} of a P-picture R-D model R_{pc}(S_{f}, MSE_{c}) corresponding to P-picture of the MPEG encoding block 2101.

The P-picture R-D model R_{pc}(S_{f}, MSE_{c}) corresponds to a curve indicated by “-▪-” in FIG. 26, and the two constants I_{c} and Θ_{c} in equation (17) are set to be I_{c}=0.15 and Θ_{c}=0.15. Also, a curve indicated by “-▴-” corresponds to the same R-D model as in FIG. 25, and a curve indicated by “-♦-” indicates the actually measured value upon encoding P-picture by the MPEG-4 encoding scheme in practice.

In FIG. 26, in a region of the rate R_{c}≧0.5, a large deviation is produced from the actually measured value in the same manner as the I-picture R-D model R_{ic}(S_{f}, MSE_{c}), but the P-picture R-D model R_{pc}(S_{f}, MSE_{c}) is not used in this region.

As described above, the differences between steps S2204 and SS206 from steps S1603 and S1605 in the second embodiment shown in FIG. 16 are that the two models, i.e., I-picture R-D model R_{ic}(S_{f}, MSE_{c}) and P-picture R-D model R_{pc}(S_{f}, MSE_{c}) are used in accordance with the picture types in place of the R-D model R_{c}(S_{f}, MSE_{c}) of the second embodiment.

Hence, in steps S2204 and S2206, the processes in steps S1603 and S1605 of the second embodiment can be executed by defining the constants I_{c} and Θ_{c} of equation (17) in accordance with the picture type.

The process in step S2205 will be described below.

In the moving image encoding apparatus 2100 of the third embodiment, the Butterworth filter block 2101 having the Butterworth characteristics is used as a pre-filter block.

As is well known, the Butterworth filter has maximally flat characteristics, and is characterized in that its frequency response characteristics are determined by the order.

In the third embodiment, the cutoff frequency is fixed, and the filter characteristics of the Butterworth filter block 2101 are changed by changing the order of the Butterworth filter.

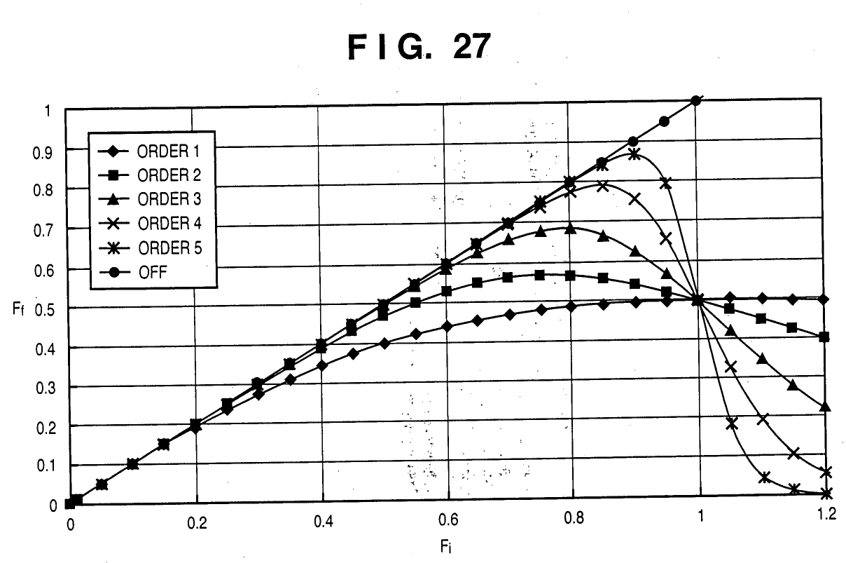

FIG. 27 shows the graph that represents the relationship between the frequency Fᵢ of the input picture of the Butterworth filter block 2101 and the filtered frequency F_{f} when the order is changed from 1 to 5.

Using the relationship between the variance Sᵢ of the input picture of the Butterworth filter block 2101 calculated in step S2201, and the variance S_{f} of the output picture of the Butterworth filter block 2101 obtained in step S2204, the order indicating the relationship between the frequencies Fᵢ and F_{f} most approximate to the relationship between the variances Sᵢ and S_{f} can be selected from curves indicating the relationships between the frequencies Fᵢ and Ff of the Butterworth filter block 2101 according to the orders shown in FIG. 27, which are determined in advance.

When the order is zero, the Butterworth filter function is disabled.

As described above, according to the third embodiment, the same effect as in the second embodiment can be obtained for the MPEG-4 encoding scheme.

As described above, according to the present invention, in the moving image encoding apparatus which includes the pre-filter block and encoding block, the pre-filter block and encoding block are controlled in consideration of the degree of deterioration of image quality and human visual characteristics. Hence, encoded moving image data which has an optimal rate and encoding distortion amount can be obtained under the condition of the allocated target rate.

More specifically, a target rate of a picture, which is determined in advance, is set in the moving image encoding apparatus. The variance Sᵢ of an input picture to the moving image encoding apparatus is calculated. Upon encoding the immediately preceding picture, the block distortion amount B_{cprev} is calculated in advance from the input picture of the encoding block and the output picture of the local decoding block.

The evaluation formula of the visual sensitivity model is determined based on the variance Sᵢ and block distortion amount B_{cprev}.

Using the determined evaluation formula of the visual sensitivity model and the specifying formula (R-D model) that specifies the relationship between the rate and encoding distortion amount of the encoding block, the variance S_{f} of the picture filtered by the pre-filter block and the encoding distortion amount MSE_{c} produced by the encoding block are calculated as solutions of the Lagrangian method with undetermined multipliers to have the target rate of the input picture as the constraint condition.

Using the variances Sᵢ and S_{f} as parameters, the filter characteristics of the pre-filter block are determined.

Furthermore, the target rate R_{c} of the encoding block is determined on the basis of the encoding distortion amount MSE_{c} and R-D model.

Using the determined target rate R_{c}, the weighting parameter of the quantization process is calculated from the specifying formula (R-Q model) that specifies the relationship between the rate of the encoding block and the weighting parameter of the quantization process.

Note that the visual sensitivity model is not limited to the evaluation formula given by equation (18) used in the second embodiment, and need only include as variables a variable corresponding to the encoding distortion amount MSEC of the R-D model of the encoding block, and the variable S_{f} of the output picture of the pre-filter block.

Furthermore, the R-Q model used to calculate the Q-scale from the target rate of the encoding block obtained from the R-D model is not limited to equation (24).

The preferred embodiments of the present invention have been explained, and the present invention can be practiced in the forms of a system, apparatus, method, program, storage medium, and the like. More specifically, the present invention can be applied to either a system constituted by a plurality of devices, or an apparatus consisting of a single equipment.

Note that the present invention includes a case wherein the invention is achieved by directly or remotely supplying a program of software that implements the functions of the aforementioned embodiments (programs corresponding to the illustrated flowcharts in the above embodiments) to a system or apparatus, and reading out and executing the supplied program code by a computer of that system or apparatus.

Therefore, the program code itself installed in a computer to implement the functional process of the present invention using the computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy (tradename) disk, hard disk, optical disk, magnetooptical disk, MO, CD-ROM, CD-R, CD-RW, magnetic tape, nonvolatile memory card, ROM, DVD (DVD-ROM, DVD-R), and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the present invention includes a WWW server which makes a plurality of users download a program file required to implement the functional process of the present invention by the computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As many apparently widely different embodiments of the present invention can be made without departing from the spirit and scope thereof, it is to be understood that the invention is not limited to the specific embodiments thereof except as defined in the claims.

### Claim of Priority

This application claims priority from Japanese Patent Application Nos. 2003-409357 filed on Dec. 8, 2003 and 2004-048173 filed on Feb. 24, 2004, which are hereby incorporated by reference herein.

1. A moving image encoding apparatus which has encoding means for quantizing and encoding a moving image, and decoding means for locally decoding the encoded data, comprising:
a pre-filter for applying a spatial filter process to the input moving image in accordance with a filter coefficient which can be variably set according to an encoding condition;
calculation means for calculating a block distortion level of the moving image on the basis of the moving image output from said pre-filter and a decoded image output from said decoding means; and
determination means for determining a parameter that changes a setup of at least one of the filter coefficient and a quantization scale required to control quantization in said encoding means in accordance with the calculated block distortion level and a rate for the moving image encoded by said encoding means.

2. The apparatus according to claim 1, wherein said determination means determines the filter coefficient not to operate said pre-filter in accordance with the calculated block distortion level.

3. The apparatus according to claim 1, wherein said determination means determines the filter coefficient to give characteristics of a pass band of a low-frequency region to said pre-filter in accordance with the calculated block distortion level.

4. The apparatus according to claim 1, wherein said determination means determines the filter coefficient to give characteristics of a pass band of a low-frequency region to said pre-filter in accordance with the calculated block distortion level, and also determines a value that changes a value of the quantization scale in accordance with the block distortion level.

5. A moving image encoding method in a moving image encoding apparatus which has encoding means for quantizing and encoding a moving image, and decoding means for locally decoding the encoded data, comprising:
a filter process step of executing a spatial filter process for the input moving image in accordance with a filter coefficient which can be variably set according to an encoding condition;
a calculation step of calculating a block distortion level of the moving image on the basis of the moving image that has undergone the spatial filter process and a decoded image output from the decoding means; and
a determination step of determining a parameter that changes a setup of at least one of the filter coefficient and a quantization scale required to control quantization in the encoding means in accordance with the calculated block distortion level and a rate for the moving image encoded by the encoding means.

6. The method according to claim 5, wherein the determination step includes a step of determining the filter coefficient not to execute the spatial filter process in accordance with the calculated block distortion level.

7. The method according to claim 5, wherein the determination step includes a step of determining the filter coefficient to give characteristics of a pass band of a low-frequency region to the spatial filter process in accordance with the calculated block distortion level.

8. The method according to claim 5, wherein the determination step includes a step of determining the filter coefficient to give characteristics of a pass band of a low-frequency region to the spatial filter process in accordance with the calculated block distortion level, and also determines a value that changes a value of the quantization scale in accordance with the block distortion level.

9. A program for implementing control of a moving image encoding apparatus which has encoding means for quantizing and encoding a moving image, and decoding means for locally decoding the encoded data, comprising:
a program module of a filter process step of executing a spatial filter process for the input moving image in accordance with a filter coefficient which can be variably set according to an encoding condition;
a program module of a calculation step of calculating a block distortion level of the moving image on the basis of the moving image that has undergone the spatial filter process and a decoded image output from the decoding means; and
a program module of a determination step of determining a parameter that changes a setup of at least one of the filter coefficient and a quantization scale required to control quantization in the encoding means in accordance with the calculated block distortion level and a rate for the moving image encoded by the encoding means.

10. A storage medium for storing a program for making a computer execute a moving image encoding method in a moving image encoding apparatus which has encoding means for quantizing and encoding a moving image, and decoding means for locally decoding the encoded data, comprising:
a code of a filter process step of executing a spatial filter process for the input moving image in accordance with a filter coefficient which can be variably set according to an encoding condition;
a code of a calculation step of calculating a block distortion level of the moving image on the basis of the moving image that has undergone the spatial filter process and a decoded image output from the decoding means; and
a code of a determination step of determining a parameter that changes a setup of at least one of the filter coefficient and a quantization scale required to control quantization in the encoding means in accordance with the calculated block distortion level and a rate for the moving image encoded by the encoding means.

11. A moving image encoding apparatus for encoding an input image to a predetermined target rate using a weighting parameter in a quantization process in moving image encoding that encodes a moving image for respective predetermined units, comprising:
variance calculation means for calculating a variance of the input image;
filter means for applying a filter process to the input image in accordance with given filter characteristics;
encoding means for encoding the input image that has undergone the filter process by said filter means by executing a quantization process;
decoding means for applying a decoding process to encoded data output from said encoding means;
detection means for detecting block distortion from an input image to said encoding means and a reconstructed image as an output from said decoding means;
specifying formula determination means for determining a specifying formula used to specify a relationship between a rate and encoding distortion amount in said encoding means;
evaluation formula determination means for determining an evaluation formula used to evaluate visual sensitivity including the variance calculated by said variance calculation means and at least the detection result of said detection means; and
parameter calculation means for calculating the filter characteristics in said filter means and a weighting parameter in a quantization process on the basis of the target rate of the input image, the specifying formula, and the evaluation formula.

12. The apparatus according to claim 11, wherein said specifying formula determination means determines the specifying formula using the variance of the input image that has undergone the filter process of said filter means, and the encoding distortion amount of said encoding means.

13. The apparatus according to claim 11, wherein the evaluation formula includes the detection result of said detection means, the variance of the input image that has undergone the filter process of said filter means, and the encoding distortion amount of said encoding means.

14. The apparatus according to claim 11, wherein said parameter calculation means calculates the variance of the input image that has undergone the filter process of said filter means and the encoding distortion amount of said encoding means, which can optimize two formulas including the specifying formula and the evaluation formula to have the target rate of the input image as a constraint condition.

15. The apparatus according to claim 14, wherein said parameter calculation means calculates the weighting parameter of the quantization process by calculating a target rate of the input image from the encoding distortion amount in said encoding means.

16. The apparatus according to claim 11, wherein said parameter calculation means calculates the variance of the input image that has undergone the filter process of said filter means and the encoding distortion amount of said encoding means using a Lagrangian method with undetermined multipliers, which maximizes or minimizes the evaluation formula, under a constraint condition that the target rate of the input image is equal to a rate of said encoding means obtained from the specifying formula.

17. A moving image encoding method for encoding an input image to a predetermined target rate using a weighting parameter in a quantization process in moving image encoding that encodes a moving image for respective predetermined units, comprising:
a variance calculation step of calculating a variance of the input image;
a filter step of applying a filter process to the input image in accordance with given filter characteristics;
an encoding step of encoding the input image that has undergone the filter process in the filter step by executing a quantization process;
a decoding step of applying a decoding process to encoded data output from the encoding step;
a detection step of detecting block distortion from an input image to the encoding step and a reconstructed image as an output from the decoding step;
a specifying formula determination step of determining a specifying formula used to specify a relationship between a rate and encoding distortion amount in the encoding step;
an evaluation formula determination step of determining an evaluation formula used to evaluate visual sensitivity including the variance calculated in the variance calculation step and at least the detection result of the detection step; and
a parameter calculation step of calculating the filter characteristics in the filter step and a weighting parameter in a quantization process on the basis of the target rate of the input image, the specifying formula, and the evaluation formula.

18. A program for implementing control of a moving image encoding apparatus for encoding an input image to a predetermined target rate using a weighting parameter in a quantization process in moving image encoding that encodes a moving image for respective predetermined units, comprising:
a program module of a variance calculation step of calculating a variance of the input image;
a program module of a filter step of applying a filter process to the input image in accordance with given filter characteristics;
a program module of an encoding step of encoding the input image that has undergone the filter process in the filter step by executing a quantization process;
a program module of a decoding step of applying a decoding process to encoded data output from the encoding step;
a program module of a detection step of detecting block distortion from an input image to the encoding step and a reconstructed image as an output from the decoding step;
a program module of a specifying formula determination step of determining a specifying formula used to specify a relationship between a rate and encoding distortion amount in the encoding step;
a program module of an evaluation formula determination step of determining an evaluation formula used to evaluate visual sensitivity including the variance calculated in the variance calculation step and at least the detection result of the detection step; and
a program module of a parameter calculation step of calculating the filter characteristics in the filter step and a weighting parameter in a quantization process on the basis of the target rate of the input image, the specifying formula, and the evaluation formula.

19. A moving image encoding apparatus for encoding an input image to a predetermined target rate using a weighting parameter in a quantization process in moving image encoding that encodes a moving image for respective predetermined units, comprising:
variance calculation means for calculating a variance of the input image;
filter means for applying a filter process to the input image in accordance with given filter characteristics;
encoding means for encoding the input image that has undergone the filter process by said filter means by executing a quantization process;
decoding means for applying a decoding process to encoded data output from said encoding means;
detection means for detecting block distortion from an input image to said encoding means and a reconstructed image as an output from said decoding means; and
parameter calculation means for calculating the filter characteristics in said filter means and a weighting parameter in a quantization process on the basis of the target rate of the input image, the output from said variance calculation means, and the output from said detection means.

20. A moving image encoding method for encoding an input image to a predetermined target rate using a weighting parameter in a quantization process in moving image encoding that encodes a moving image for respective predetermined units, comprising:
a variance calculation step of calculating a variance of the input image;
a filter step of applying a filter process to the input image in accordance with given filter characteristics;
an encoding step of encoding the input image that has undergone the filter process in the filter step by executing a quantization process;
a decoding step of applying a decoding process to encoded data output from the encoding step;
a detection step of detecting block distortion from an input image to the encoding step and a reconstructed image as an output from the decoding step; and
a parameter calculation step of calculating the filter characteristics in the filter step and a weighting parameter in a quantization process on the basis of the target rate of the input image, the output from the variance calculation step, and the output from the detection step.

21. A moving image encoding apparatus which has an encoding unit being arranged to quantize and encode a moving image, and a decoding unit being arranged to local-decode the encoded data, comprising:
a pre-filter, arranged to apply a spatial filter process to the input moving image in accordance with a filter coefficient which can be variably set according to an encoding condition;
a calculator, arranged to calculate a block distortion level of the moving image on the basis of the moving image output from said pre-filter and a decoded image output from said decoding unit; and
a determination unit, arranged to determine a parameter that changes a setup of at least one of the filter coefficient and a quantization scale required to control quantization in said encoding unit in accordance with the calculated block distortion level and a rate for the moving image encoded by said encoding unit.

22. A moving image encoding apparatus for encoding an input image to a predetermined target rate using a weighting parameter in a quantization process in moving image encoding that encodes a moving image for respective predetermined units, comprising:
a variance calculator, arranged to calculate a variance of the input image;
a filter, arranged to apply a filter process to the input image in accordance with given filter characteristics;
an encoding unit, arranged to encode the input image that has undergone the filter process by said filter by executing a quantization process;
a decoding unit, arranged to apply a decoding process to encoded data output from said encoding unit;
a detector, arranged to detect block distortion from an input image to said encoding unit and a reconstructed image as an output from said decoding unit; and
a parameter calculator, arranged to calculate the filter characteristics in said filter and a weighting parameter in a quantization process on the basis of the target rate of the input image, the output from said variance calculator, and the output from said detector.
